(19) United States
(12) Patent Application Publication
(10) Pub. No.: US 2012/0126538 A1
(43) Pub. Date: May 24, 2012

(54) Regenerating generator also known as automatic energy saving machine

(76) Inventor: William J. Pierre, Bonita, LA (US)

(21) Appl. No.: 12/807,757

(22) Filed: Nov. 23, 2010

(51) Int. Cl. H02K 7/20; H02K 53/00

(52) U.S. Cl. 290/50; 74/DIG. 9

(57) ABSTRACT

My machine is an Energy Saving Machine. This machine will be used to power your home, boats, anywhere where electricity is needed and used.

This machine is a device that can hook up to your power pole box or the breaker box in your home. This machine will allow home owners, Business owners and anyone else with who will want to save money on their power bill.

The main components of the machine are the Automatic Energy Saving Machine, charger, battery and DC/AC converter. The charger charges the battery; the battery is plugged into the DC/AC converter, which in turn, transforms the energy into usage household 110 or 220 electricity. This Automatic Energy Saving Machine will remap how electricity is used in all aspects of our daily lives

### CONCEPTION OF INVENTION

My electric bill was too high. I started tinkering with a fuel operated generator that had no motor. I put a bicycle sprocket into the generator where the motor goes, turned the bike upside down, hooked the bike chain to the sprocket. I peddled the bike by hand. The generator turned on.

Then I got an electric motor from a cloths dryer. The shaft of the motor didn't fit the generator. I added a galvanized pipe to the electric motor by drilling holes into the shaft and pipe. I put a pin inside the holes to hold pieces together.

Cut galvanized pipe about ½ into an “X” shape to make it into a point. It then fit the generator shaft. I ran a regular extension cord with ends cut off and spliced into motor. The other end I connected to a 12 (twelve) volt battery. Generator started working. I got a battery charger and plugged it into a 110 volt socket of the generator. I took the battery cables and connected them to the battery charger and clamped them onto the 12 (twelve) volt battery. I got a timer switch, a converter box to charger the battery from DC to AC current. I added a 3 (three) speed timer switch between converter and motor. I then Ran extension cords to living room and kitchen sockets, while electricity was on. I turned off main breaker box switch and my lights were still on. I noticed a significant reduction in my electric bills.

The purpose of my invention is to save energy by eliminating the need for fuel, filters, sparks plugs, oil, radiators, water pumps and possibly transmissions and their fluids. My Automatic Energy Saving Machine has proven to save electricity and takes up a minimal amount of space. It must be kept away from water, rain and moisture. Turn machine off in case of flooding, to avoid electrical shock.

Also the machine will help the U.S. Government, private citizens and possibly businesses and third world countries, with heating and cooling expenses without the cost of electricity being sky high.

There is no pollution with my machine, and the sound is minimal. Therefore boosting our economy and allowing change (for the better) to our environment by going greener. Black outs will be a thing of the past. Very little maintenance is required. Just a few drops of 3 (three) in 1 (one) oil within 3 (three) to 6 (six) months.

I use the highest quality parts that are available to me. I will offer one year limited warranty. If the Automatic Energy Saving Machine is tampered with in any way the warranty is voided and no longer valid. The machine is expected to last longer than one year.

Keep away from children.

To avoid electric shock do not open or tamper with the Automatic Energy Saving Machine.

My Automatic Energy Saving Machine can be self contained. It recharges itself and can be used for electrical equipment or appliances only.

Campers, boats, R.V's, hunting, fishing, camping and hiking enthusiasts will all benefit from my invention.

### DETAILS FOR DRAWING

FIG. 1: Automatic Energy Saving Machine is attached to FIG. 2 electric timer (set for 8 (eight) hours). FIG. 3 Electric Charger (12 (twelve) volts or higher) is connected to FIG. 2, the electric timer. FIG. 3: electric charger is connected to FIG. 4 battery (12 (twelve) volts or higher). FIG. 4 battery (12 (twelve) volts or higher) is connected to FIG. 5 converter (110 or 220) in the DC/AC order. From FIG. 5 converter is connected to FIG. 6 speed control (3 (three) settings) with 100 or 220 electrical wire to coincide with FIG. 7 electric motor (½ horse power or higher) FIG. 7 is connected to FIG. 8 the Drive shaft coupling, which is connected to FIG. 1, the Automatic Energy Saving Machine.

FIG. 1: Automatic Energy Saving Machine can be attached to main breaker box with 110 & 220 voltage electrical wire or plugged into the house sockets with a heavy duty extension cord.

This system can be applied to any electrical machinery or electrical device. It can also apply to fuel operated machinery or devices other then propane or gas. My machine needs a timer set for 8 (eight) hours to recharge the battery. The battery is converted to a DC/AC converter box with a low, medium and high setting switch which is then attached to AC 110 or 220 voltage electric wires to operate the electric motor. This connects back to the Automatic Energy Saving Machine and regenerates power to itself and/or the electric meter or house wall socket by extension cords.

Why I think this is my invention:

No one has came out with a more cost efficient energy source. So I got mad at the cost of my electric bill. So I went to work on a more cost efficient way for providing electricity and this is what I came up with, the Automatic Energy Saving Machine.

### Legend

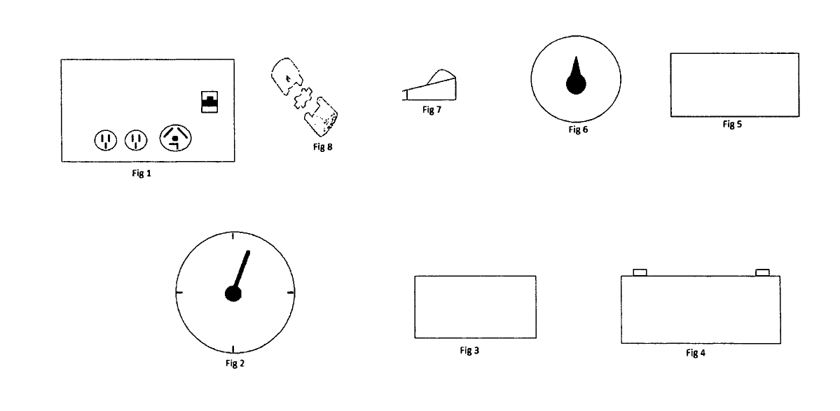

FIG. 1—Automatic Energy Saving Machine

FIG. 2—Timer (times for 8 (eight) hours)

FIG. 3—Charger (12 (twelve) volts or higher)

FIG. 4—Battery (12 (twelve) volts or higher)

FIG. 5—DC/AC Converter

FIG. 6—Speed Control (3 (three) settings)

FIG. 7—Electric Motor (½ horse power or higher)

FIG. 8—Drive Shaft Coupling

The embodiments of the invention in which an exclusive property or privilege is claimed are defined as follows:

1. The Automatic Energy Saving Machine, is a generator that supplies the power to all the components in the machine, as well as all the output electrical outlets. The Automatic Energy Saving Machine consists of one or more 110 electrical outlets, one or more 220 electrical outlets. The Automatic Energy Saving Machine has an on and off switch, or button, that turns the machine on or off. The Automatic Energy Saving Machine can be connected to the main power pole box, utility box, or the main electrical breaker box in your home, business, or anywhere you can receive electricity.

2. The Automatic Energy Saving Machine of claim 1, consists of a timer, which the user can either control how long the Automatic Energy Saving Machine is left running or used. The timer consists of a digital or analog clock, that measures the timed usage of The Automatic Energy Saving Machine.

3. The Automatic Energy Saving Machine of claim 1, further comprising a 12 volt or higher charger to charge the battery or batteries in The Automatic Energy Saving Machine. The charger is connected to the timer of claim 2, which allows for timed charges, as well as stopping periods.

4. The Automatic Energy Saving Machine of claim 1, comprising of a 12 volt or higher battery, which is connected to claim 3. The battery is the main power source for The Automatic Energy Saving Machine, helping run and backup power for claims 2, 3, 5, 6, 7 and 8.

5. The Automatic Energy Saving Machine of claim 1, is comprised of a DC/AC converter, which is connected to claim 4, the battery. The DC/AC converter transforms the generators DC current to a useable AC current, allowing the user to run 110 and 220 appliances and machinery, or anything that uses electricity.

6. The Automatic Energy Saving Machine of claim 1, is comprised of a 3 setting speed control setting. The 3 setting speed control controls how much power is generated in The Automatic Energy Saving Machine. This device allows the user to decide how much power is released to better maintain the life span of the machine when a lower payload of energy is used. The user may set the controller to low, if the user needs more power, the control can be set to medium or high, depending on how much power is needed for more energy. Therefore running more devices that can be used for power.

7. The Automatic Energy Saving Machine of claim 1 is comprised of a coupling. This coupling is connected to claim 8 the motor. This coupling acts as a driveshaft for the motor, which is connected to the generator, The Automatic Energy Saving Machine.

8. The Automatic Energy Saving Machine of claim 1 is comprised of a motor (½ horse power or higher). The motor powers the generator. The motor is a device that is connected to claim 7 the coupling. The motor turns the coupling.
